(19) United States
(12) Patent Application Publication
(10) Pub. No.: US 2005/0085189 A1
(43) Pub. Date: Apr. 21, 2005

(54) Communications apparatus and method

(76) Inventor: Sally Hansen, Ottawa (CA)

Correspondence Address: LAHIVE & COCKFIELD, LLP., 28 STATE STREET, BOSTON, MA, 02109, US

(21) Appl. No.: 10/913,240

(22) Filed: Aug. 6, 2004

Related U.S. Application Data
(60) Provisional application No. 60/493,204, filed on Aug. 6, 2003.
(60) Provisional application No. 60/501,362, filed on Sep. 8, 2003.

(51) Int. Cl. H04B 7/00

(52) U.S. Cl. 455/41.2

(57) ABSTRACT

A communication system and corresponding method facilitate voice and message communications and may be implemented to provide multiple message delivery modes including voice and text, while maintaining privacy and specificity of message delivery. The method of establishing a communication link includes receiving a request for communication from a source party including a designated party identifier based on at least one of a designated party optical cue and a designated party transmission. The designated party identifier is associated with a matching designated party. The communication link between the source party and the designated party can then be established, either automatically based on the request, or subsequent to acceptance and/or instruction from the designated party to establish the communication link.

### RELATED APPLICATION

This application claims priority to, and the benefit of, co-pending U.S. Provisional Application No. 60/493204, filed Aug. 6, 2003, and co-pending U.S. Provisional Application No. 60/501362, filed Sep. 8, 2003 for all subject matter common to all applications. The disclosures of said provisional applications are hereby incorporated by reference in their entirety.

### FIELD OF THE INVENTION

The present invention relates to a system and method for establishing communication, and more particularly to enablement of communications between two or more parties based at least in part on the ability of a communication initiator to identify a target party by observation, location, membership in a group, and/or proximity.

### BACKGROUND OF THE INVENTION

Conventionally, electronic communications between two or more parties (a source party and a designated party) require the source party to have specific addressing knowledge of the designated party. Conventional telephony for example, (as opposed to open-channel radio media such as ‘walkie-talkie’ or CB Radio networks) requires explicit knowledge, such as a telephone number.

Recently a “push-to-talk” feature incorporated into cell phones has allowed some of the features of broadcast media to be introduced to telephony. However, there is still a requirement for specification of designated party address information. The source party must first enter the designated party's telephonic address into the cell phone before attempting a “push-to-talk” communication.

In addition, communications from a plurality of sources to a single designated party, or from a single source party to a plurality of designated parties, are also complicated by the requirement of needing the specific telephonic address information. For example, if a source party wished to contact a group of individuals each having a separate telephonic address, the source party must individually and specifically target each telephonic address to contact each designated party.

### SUMMARY OF THE INVENTION

There is a need for a communication system that facilitates voice and message communications and may be implemented to provide multiple message delivery modes including voice and text, while maintaining privacy and specificity of message delivery. The present invention is directed toward further solutions to address this need.

In accordance with one aspect of the present invention, in an electronic device, a method of establishing a communication link includes receiving a request for communication from a source party including a designated party identifier based on at least one of a designated party optical cue and a designated party transmission. The designated party identifier is associated with a matching designated party. The communication link between the source party and the designated party is then established between the source party and the designated party.

In accordance with one embodiment of the present invention, the request for communication is forwarded to the matching designated party. If the matching designated party accepts the request, the designated party returns an instruction to establish the communication link. In accordance with an alternative embodiment, the communication link is established based on the request and without requiring an acceptance or instruction by the designated party.

In accordance with aspects of the present invention, the source party sends the request using a wireless device, such as a mobile phone, a personal digital assistant, or a wireless communicator.

In accordance with further aspects of the present invention, the designated party optical cue includes at least one of visual tags, license plates, number tags, bar-codes, scannable codes, printed T-shirts, signs, pins, buttons, badges, arm bands, bibs, name tags, and displays of distinguishing information. The designated party transmission includes at least one of near infra-red (NIR) tag signals, RF-ID tag signals, transponder signals, magnetic signals, Bluetooth signals, IR signals, wireless Ethernet signals, RF signals, WiFi signals, GPS, and optical signals.

In accordance with further aspects of the present invention, associating the designated party identifier with a matching designated party includes comparing the designated party identifier against a correspondence list to match the designated party with the designated party identifier. The correspondence list includes a list of at least one designated party identifier, and a correlation between the at least one designated party identifier and at least one designated party. The correspondence list further includes information conveying a method for contacting the at least one designated party.

In accordance with further aspects of the present invention, forwarding the request for communication to the matching designated party includes transmitting a signal to the matching designated party indicating the existence of the request for the communication link. The matching designated party accepts the request by transmitting an acceptance. Completing the communication link includes electronically linking the source party with the designated party to enable the conveyance of information between the source party and the designated party.

In accordance with further aspects of the present invention, the source party and the designated party are each comprised of an individual, a plurality of individuals, an entity, a plurality of entities, an electronic device, and/or a plurality of electronic devices. The source party can indicate whether to convey identification information about the source party to the designated party. The source party can base the conveyance of identification information on the occurrence of a condition. The condition can include at least one of the designated party accepting the request, and the designated party conveying identification information about the designated party to the source party. Furthermore, the designated party can indicate whether to convey identification information about the designated party to the source party. The designated party can base the conveyance of identification information on the occurrence of a condition. The condition can include the source party conveying identification information about the source party to the designated party.

In accordance with further aspects of the present invention, prior to receiving the request for communication from the source party, the designated party subscribes to a service providing the method of the establishment of the communication link.

In accordance with further aspects of the present invention, the method further includes forwarding a billing message conveying billing information to at least one of the source party and the designated party based on use of the communication link.

The request for communication can include a digital image. In addition, the method can be implemented in a resort environment, a group meeting environment, a social engagement environment, a transportation environment, an emergency response environment, and a conference environment, or other event or setting.

In accordance with one embodiment, a method of establishing a communication link includes a source party sending a request for communication with a designated party including a designated party identifier based on at least one of a designated party optical cue and a designated party transmission. The method continues with one of receiving an indication of the request being declined, and receiving an indication of the request being accepted and the communication link being completed.

In accordance with aspects of the present invention, the source party sends the request using a wireless device, such as one of a mobile phone, a personal digital assistant, and a wireless communicator.

In accordance with further aspects of the present invention, the designated party optical cue includes at least one of visual tags, license plates, number tags, bar-codes, scannable codes, printed T-shirts, signs, pins, buttons, badges, arm bands, bibs, name tags, and displays of distinguishing information. The designated party transmission includes at least one of near infra-red (NIR) tag signals, RF-ID tag signals, transponder signals, magnetic signals, Bluetooth signals, IR signals, wireless Ethernet signals, RF signals, WiFi signals, GPS, and optical signals.

In accordance with further aspects of the present invention, the designated party identifier is compared with a correspondence list to match the designated party with the designated party identifier. The correspondence list includes a list of at least one designated party identifier, and a correlation between the at least one designated party identifier and at least one designated party. The correspondence list can further include information conveying a method for contacting the at least one designated party.

In accordance with further aspects of the present invention, the communication link being completed includes electronically linking the source party with the designated party to enable the conveyance of information between the source party and the designated party.

In accordance with further aspects of the present invention, the source party and the designated party are each comprised of an individual, a plurality of individuals, an entity, a plurality of entities, an electronic device, and/or a plurality of electronic devices. The source party can indicate whether to convey identification information about the source party to the designated party. The source party can base the conveyance of identification information on the occurrence of a condition. The condition includes at least one of the designated party accepting the request, and the designated party conveying identification information about the designated party to the source party.

In accordance with further aspects of the present invention, the designated party can indicate whether to convey identification information about the designated party to the source party. The designated party can base the conveyance of identification information on the occurrence of a condition. The condition includes the source party conveying identification information about the source party to the designated party.

In accordance with further aspects of the present invention, prior to receiving the request for communication from the source party the designated party can subscribe to a service providing the method for establishment of the communication link.

In accordance with further aspects of the present invention, the method further includes forwarding a billing message conveying billing information to at least one of the source party and the designated party based on use of the communication link.

The request for communication can include a digital image. In addition, the method can be implemented in a resort environment, a group meeting environment, a social engagement environment, a transportation environment, an emergency response environment, and a conference environment, or other event or setting.

In accordance with one embodiment of the present invention, a communication system for establishing a communication link includes a receiver for receiving communications from a source party and a designated party. A request processor processes a request for establishing the communication link. A database accessible by the electronic device is provided, wherein the database stores a correspondence list correlating at least one attribute from the request that corresponds to at least one designated party with information conveying a method for contacting the at least one designated party. A transmitter transmits communications to the source party and the designated party.

In accordance with aspects of the present invention, the source party sends the request using a wireless device, such as a mobile phone, a personal digital assistant, and a wireless communicator.

In accordance with further aspects of the present invention, the at least one attribute includes at least one of visual tags, license plates, number tags, bar-codes, scannable codes, printed T-shirts, signs, pins, buttons, badges, arm bands, bibs, name tags, and displays of distinguishing information. The at least one attribute can further include at least one of near infra-red (NIR) tag signals, RF-ID tag signals, transponder signals, magnetic signals, Bluetooth signals, IR signals, wireless Ethernet signals, RF signals, WiFi signals, GPS, and optical signals.

In accordance with further aspects of the present invention, the transmitter for transmitting communications to the source party and the designated party serves as a relay between the source party and the designated party forming the communication link.

In accordance with further aspects of the present invention, the source party and the designated party are each comprised of an individual, a plurality of individuals, an entity, a plurality of entities, an electronic device, and/or a plurality of electronic devices. The request for establishing the communication link can be in the form of a digital image.

In accordance with additional aspects of the present invention and by way of example, the source party and the designated party are located in at least one of a resort environment, a group meeting environment, a social engagement environment, a transportation environment, an emergency response environment, and a conference environment, or other event or setting.

### BRIEF DESCRIPTION OF THE DRAWINGS

The present invention will become better understood with reference to the following description and accompanying drawings, wherein:

FIG. 1 is a diagrammatic illustration of a basic configuration for providing a communication link, according to one aspect of the present invention;

FIG. 2 is a diagrammatic illustration of a communication enabler, according to one aspect of the present invention;

FIG. 3 is a flowchart illustrating one example method for establishing a communication link, according to one aspect of the present invention;

FIG. 4 is a diagrammatic illustration of an electronic device for implementing the method in accordance with one embodiment of the present invention; and

FIGS. 5A, 5B, and 5C are diagrammatic illustrations of various source party and designated party configurations, according to one aspect of the present invention;

### DETAILED DESCRIPTION

An illustrative embodiment of the present invention relates to a system and method that enables mobile phone users, or other users of other personal communications devices, to establish communication with new destinations by specifying information which is linked through an address-correspondence list within a communications network. Such a system and method can provide for the establishment of specified 1:1 linkages, 1:many linkages, many:1 linkages, or many:many linkages according to routing protocols. The routing protocols can be programmed into network switching systems including, without limitation, telephonic as well as IP based systems. In addition, billing information can be programmed into the network switching systems, or implemented in a separate system, such as text messaging which is linked to use of the system and separate from the host network billing.

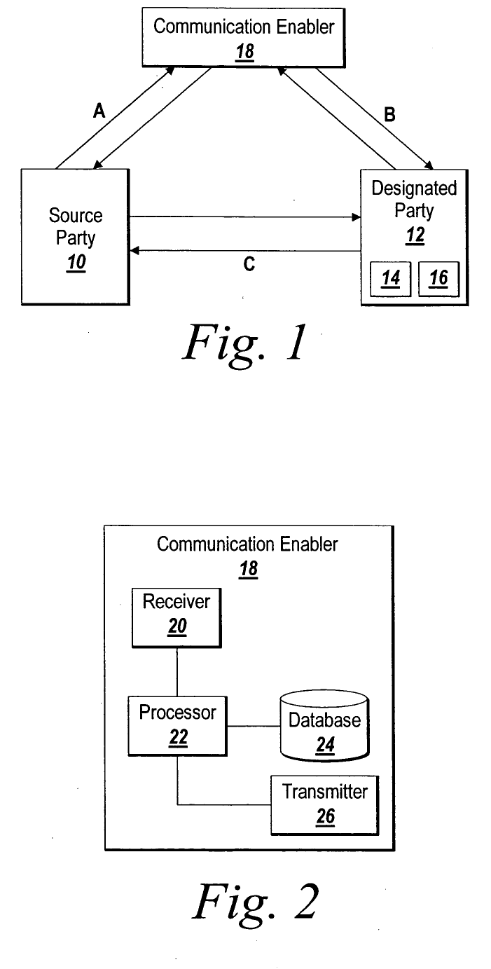

FIGS. 1 through 5C, wherein like parts are designated by like reference numerals throughout, illustrate example embodiments of a system and method for establishing communication links according to the present invention. Although the present invention will be described with reference to the example embodiments illustrated in the figures, it should be understood that many alternative forms can embody the present invention. One of ordinary skill in the art will additionally appreciate different ways to alter the parameters of the embodiments disclosed in a manner still in keeping with the spirit and scope of the present invention.

FIG. 1 is a diagrammatic illustration of the basic configuration of the system and method for establishing a communication link in accordance with one embodiment of the present invention. In the illustrative figure, a source party 10 wishes to establish a communication link with a designated party 12. However, the source party 10 does not have a telephone number, pager number, email address, or other specific address to be able to initiate the communication link. The present invention makes available to the source party at least one designated party identifier in the form of an optical cue 14 or reference to a designated party transmission 16 that the source party 10 can use to request a communication link.

Prior to describing the system and method in detail, the following overview of one embodiment of the invention is provided. In order to initiate the establishment of the communication link, the source party 10 contacts a communication enabler 18 requesting a communication link with the designated party 12 and providing a designated party identifier, such as the optical cue 14 and/or information concerning the designated party transmission 16. After matching the designated party identifier to the designated party 12, the communication enabler 18 forwards the request to the designated party 12. If the designated party chooses to accept the request, the communication enabler 18 establishes a communication link between the source party 10 and the designated party 12.

It should be noted that the source party 10 and the designated party 12 can have a number of different forms. For example, the source party 10 and the designated party 12 can be individuals, entities, electronic devices, and/or groups of individuals, entities, or electronic devices. In the instance of entities, such entities can provide instruction and participate in establishing communication links using individuals and/or electronic devices. In the instance of electronic devices, such devices can be configured to automatically recognize designated party identifiers and then execute algorithms to initiate the communication links in accordance with the present invention.

One example embodiment of the communication enabler 18 is diagrammatically depicted in FIG. 2. The communication enabler 18 includes a receiver 20, a processor 22, a database 24, and a transmitter 26. Each of the components identified can be in singular or plural form, such that the communication enabler can have a plurality of receivers 20, processors 22, databases, 24, and transmitters 26, if desired or required to implement the method of the present invention. Accordingly, when each of the aforementioned components is referred to herein in the singular, what is intended is either the singular or plural form of said component.

The receiver 20 is configured to receive signals from the source party 10 and the designated party 12. When the source party 10 submits a request for a communication link, the receiver 20 receives that request. When the designated party 12 responds to a request, the response is taken in by the receiver 20. Likewise, the transmitter 26 is configured to transmit signals from the source party 10 and the designated party 12. When the source party 10 submits a request for a communication link, the transmitter 26 forwards the request to the designated party 12. When the designated party 12 responds to a request, the response is eventually forwarded to the source party 10 by the transmitter 26.

The specific technology of the receiver 20 and the transmitter 26 can vary as would be understood by one of ordinary skill in the art. For example, both the receiver 20 and transmitter 26 can be configured to operate using infrared signals, laser signals, RF signals, any number of mobile phone signals, pager signals, and other wireless signals, as well as magnetic or other communication signal formats.

The processor 22 has several functions. The intake of signals by the receiver 20 is sent to the processor. The processor can send signals out of the communication enabler 18 using the transmitter 26. The processor 22 manages the interaction between the source party 10 and the designated party 12. Any user defined preferences are executed by the processor 22 as well as basic system operation. The processor is communicatively coupled with at least one database 24. The database 24 can store system operational information, as well as contact lists for implementing the method of the present invention as described below. The database 24 can also store information concerning the various formats and technologies for communication, including specific configuration requirements for proprietary networks.

The combination of the components of the communication enabler 18 can be configured to establish communication links between the source party and the designated party 12 using external communication services, and/or can actually provide the support for relaying a communication link between the source party 10 and the designated party 12.

Cooperative with the establishment of the communication links, the communication enabler 18 can also track and operate billing procedures. For example, the communication enabler 18 can communicate with the various formats and technologies for communication, including proprietary networks, to forward bills to the users of the communication link. Alternatively, the communication enabler 18 can send out its own bills to users directly; using text messaging or other protocols as will be later described herein.

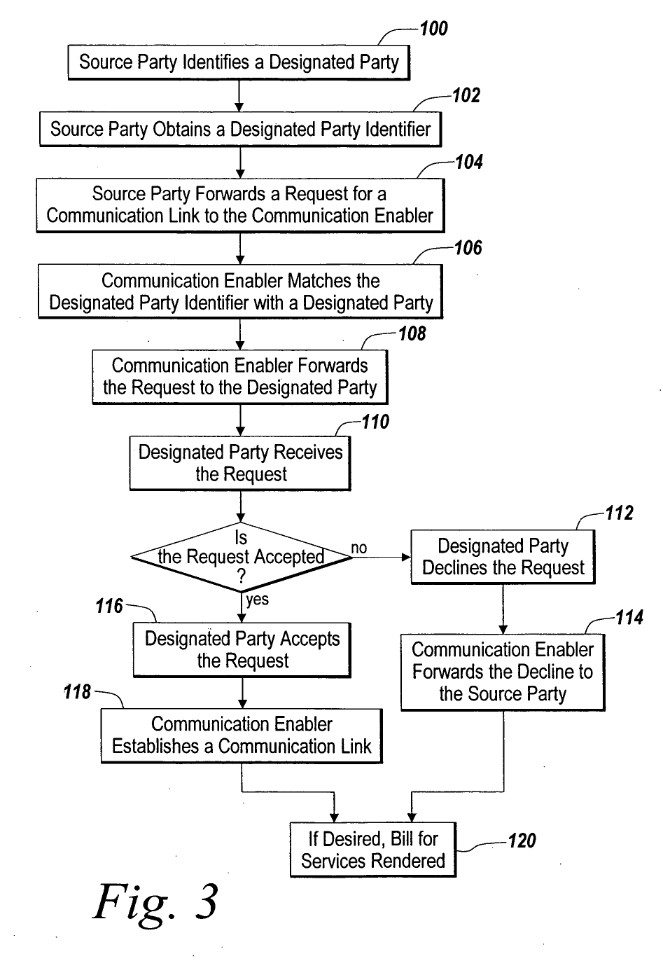

Turning now to an exemplary embodiment of the method of the present invention, FIG. 3 illustrates a flowchart describing the establishment of a communication link. The source party 10 first identifies the designated party 12 with which the source party 10 wishes to establish a communication link (step 100). As previously mentioned, the designated party 12 can be individuals, entities, electronic devices, and/or groups of individuals, entities, or electronic devices having a commonality. For example, in the instance of a group of individuals or entities, the designated party can be public safety, emergency, or first responders, conference attendees, resort attendees or staff or related parties, facilities users or maintenance workers, and/or event attendees.

The designated party 12 whether single or plural, must have submitted communication information to the communication enabler 18 prior to the source party 10 identifying the designated party 12 and attempting communication therewith. Specifically, the designated party 12 essentially subscribes to the communication enabler 18, or is pre-registered with the communication enabler 18, and provides contact information and potentially preferences. For example, when the designated party 12 wishes to be able to be communicated with through the communication enabler, the designated party 12 provides such information as, e.g., name, mobile phone number, pager number, email address, or other form of address, such that the communication enabler can communicate with the designated party 12. The contact information is that which is not readily known or apparent to the source party 10 wishing to establish the communication link.

The designated party 12 can also provide a set of rules or preferences in the form of conditions as to how or when the designated party 12 is to be communicated with by the communication enabler 18. Such conditions can include time of day for receiving requests, whether the requests must include a form of identification of the source party, whether the designated party wants to respond with additional identification information back to the source party, and/or whether the designated party should be included in a pre-determined group of individuals, entities, or devices (such as safety worker or maintenance worker) so that any communications sent to the group having the commonality goes to the designated party. One of ordinary skill in the art will appreciate that the conditions can extend well beyond that which is listed herein, and that the present invention anticipates numerous other embodiments where default preferences or conditions, and/or user specified preferences or conditions, can be configured to operate in accordance with the method of the present invention.

The source party 10, after identifying the designated party 12 in some manner, obtains a designated party identifier (step 102). The designated party identifier provides the source party 10 with a way to identify the designated party without having specific knowledge of how to establish the communication link. Said differently, absent such information as a telephone number, email address, pager number, or other form of electronic communication address, the source party 10 must obtain some other identifier to indicate with whom the source party 10 would like to communicate. The designated party identifier can be described as a tag in the form of, for example, an optical cue, or a designated party transmission.

The optical cue can take a number of different forms. For example, the optical cue can be visual tags, license plates, number tags, bar-codes, scannable codes, printed T-shirts, signs, pins, buttons, badges, arm bands, bibs, name tags, and displays of distinguishing information. In addition, the optical cue can be intrinsic or extrinsic, including such optical references as facial recognition, image recognition, or other automated optical methodology. The optical cue can be captured, for example, by a digital camera wherein the resulting digital image contains some form of discernable information that can be interpreted by the communication enabler 18. The example of license plates is associated with the source party 10 observing a vehicle with which the source party 10 wants to communicate, and identifying that vehicle and designated party, via the license plate on the vehicle. Either an image of the plate, or the characters on the plate, can be captured and used as the designated party identifier. In the instance of a visual tag, such tag can be a pin or sign, or other form of visual plaque that is observable by the source party 10 and contains some form of discernable information (such as a code, attribute, or other distinguishing feature) that can be forwarded to the communication enabler 18.

The designated party transmission is another form of tag that serves as the designated party identifier. The transmission can include near infra-red (NIR) tag signals, RF-ID tag signals, transponder signals, magnetic signals, Bluetooth signals, IR signals, wireless Ethernet signals, RF signals, WiFi signals, GPS, and optical signals. The transmission can be one that is a constant signal transmission, an intermittent signal transmission, or a transmission in response to a pinging action, such as the transponder example. Although the source party 10 does not have the specific addressing information, the transmission information can be collected and forwarded to the communication enabler 18. In the instance of the designated party transmission, the source party 10 does not necessarily need to be able to see or observe the designated party 12 to receive the transmission. The designated party 12 can be identified by proximity to the source party 10 (for example, within a 100 yard radius), and/or conditions entered by the designated party 12 (for example, first response or maintenance worker).

Continuing with the exemplary method of the present invention, the source party forwards a request to the communication enabler 18 for the establishment of a communication link with the designated party 12 (step 104). The request includes the designated party identifier information. The request can also include a set of rules or preferences in the form of conditions as to how or when the source party 10 is to be communicated with by the communication enabler 18, and what information to give the designated party 12. Such conditions can include time of day for receiving responses, whether the responses must include a form of identification of the designated party, and/or whether the source party wants to send the request with additional identification information. One of ordinary skill in the art will again appreciate that the conditions can extend well beyond that which is listed herein, and that the present invention anticipates numerous other embodiments where default preferences or conditions, and/or user specified preferences or conditions, can be configured to operate in accordance with the method of the present invention.

The communication enabler 18 matches the designated party identifier with the designated party 12 (step 106). The matching is carried out, for example, by the processor 22 of the communication enabler 18 referencing the database 24. The database 22, in this example, contains a correspondence list that defines correlations between attributes or designated party identifiers and the targeted designated party. When the communication enabler 18 receives the request and the designated party identifier, the communication enabler 18 accesses the database 22 to find a designated party 12 that corresponds with the designated party identifier provided by the source party 10. The communication enabler 18 thus seeks and establishes a match with the designated party 12 that was identified by the source party 10.

The communication enabler 18 then uses the contact information obtained from the database 24 to forward the request to the designated party 12 (step 108). In this manner, the designated party remains anonymous to the source party 10, along with the designated party's specific addressing or contact information. Yet, the designated party 12 is made aware that the source party 10 is attempting to establish a communication link with the designated party 12.

The designated party 12 receives the request and a determination is made whether to accept the invitation to establish a communication link (step 110). If the designated party does not wish to accept the request/invitation, the designated party 12 declines the request (step 112). The communication enabler 18 receives notification from the designated party 12 that the designated party 12 does not wish to establish the communication link, and forwards the decline or refusal to the source party 10 (step 114).

In the alternative, the determination can be made by the user to accept, or the determination can be automated to accept invitations offered by the requests. Said differently, the designated party 12 can either accept the invitation offered by the request, or may be automatically required to accept the invitation offered by the request. In the instance of the designated party 12 reviewing the request, the designated party 12 can then indicate that the invitation to establish the communication link is accepted. In the instance of an automated acceptance process, the designated party 12 receives the request and without further action by the designated party, the invitation is automatically accepted to establish the communication link. The automated process can be implemented both at the user level (in the remote device operated by the designated user 12) or at the level of the communication enabler 18. In either instance, the designated party 12 accepts (either manually or automatically) the invitation to establish the communication link (step 116).

The automated determination and acceptance process is exemplified by a scenario such as in an emergency response environment. The designated party 12 can be a police officer on duty. When the source party 10 has an emergency situation, it can be desirable for the police officer to not have to go through the manual acceptance process to establish the communication link. Instead, whenever a source party having an emergency needs to reach the police officer, the request from the source party is automatically accepted by the designated party 12 police officer, which simplifies and speeds up the process for establishing the communication link. The designated party 12 can also include preferences and conditions to be attached to the acceptance of the request and invitation to establish a communication link. The preferences and conditions can be those that were enumerated previously, or others not specifically listed as examples herein.

Assuming all conditions are met, and the acceptance has been indicated (either manually or automatically) the communication enabler 18 establishes a communication link between the source party 10 and the designated party 12 (step 118). The communication link can have two basic forms. The first form of communication link involves the communication enabler 18 continuing to serve as an intermediary relaying messages back and forth between the source party 10 and the designated party 12. This first form is illustrated in FIG. 1, where link A represents bi-directional communication between the source party 10 and the communication enabler 18, and link B represents bi-directional communication between the communication enabler 18 and the designated party 12. When the source party 10 sends a communication to the designated party, the path actually followed is through the communication enabler 18 and then to the designated party 12. The same occurs in the opposite direction for communications from the designated party 12 to the communication enabler 18 and then to the source party 10.

The second form of communication link involves a direct link established between the source party 10 and the designated party 12. This is accomplished by the communication enabler 18 opening up the line of communication using an external network (such as a mobile phone network or pager network) and effectively handing off the link to the source party 10 and the designated party 12 upon activation of the link. This configuration is illustrated in FIG. 1 as link C. In this embodiment, the communication enabler 18 sets up the communication link C and then is removed from the communication process, allowing the source party 10 and the designated party 12 to communicate directly with each other.

If desired, the method can continue with the issuance of a bill for services rendered (step 120). With regard to billing for the service provided by the communication enabler 18 of the present invention, billing can be implemented a number of different ways. Bills can bent sent to groups attending a conference, bills can be aggregated into a conference fee for attending the conference, the users of the service can be billed, bills can be sent for failed attempts to establish links, or the service can be free.

More specifically, the service provided by the communication enabler 18 can be billed in a number of different ways. The communication enabler 18 can track indicators for billing purposes, such as initiation of a communication link, acceptance of a communication link, number of messages conveyed, time duration of communication links, and the like. In short, the bill can be determined in accordance with numerous billing models as known by those of ordinary skill in the art.

The bill is then sent to the source party, the designated party, the communication network providers, or an interim third party such as a conference host, as desired. More specifically, the method for conveying the bill can be implemented within the existing network billing structures and operations, or can be implemented outside of such infrastructures, such as by a separate text message, email, or other communication separate from the communication link, or coupled with the occurrence of the communication link. The communication enabler 18 can send a bill to the host network, or to a party such as the source party 10, the designated party 12, or event operator.

For example, one form of billing can be implemented where a link between a voice message and a text message can allow the operator of the communication enabler 18 to send out a bill to either or both of the source party 10 and the destination party 12 in conjunction with receiving the communication link and separated from any charges paid by each party to their own communication providers (such as mobile phone networks, et al.).

Such a link can greatly facilitate the utility of the invention since it allows facile incorporation of the value-added services provided by the system and method of the present invention, with the ability to enter the host network's billing systems, or with the ability to operate outside of the host network's billing systems. Said differently, the generation of a billable message (eg: Thanks for using the link service) and passing that message to the responsible party creates a separate billing activity that can either be dealt with by the network service provider or handled by a separate billing service which just adds a line item to a statement.

In another example billing implementation, the communication enabler 18 sends a bill to the host network, to be entered into the host network's billing system. Again, the bill can be directed to either or both of the source party 10 and the destination party 12, or an interim provider, in conjunction with receiving the communication link. However the bill could be combined with charges paid by each party to their own communication providers (such as mobile phone networks, et al.).

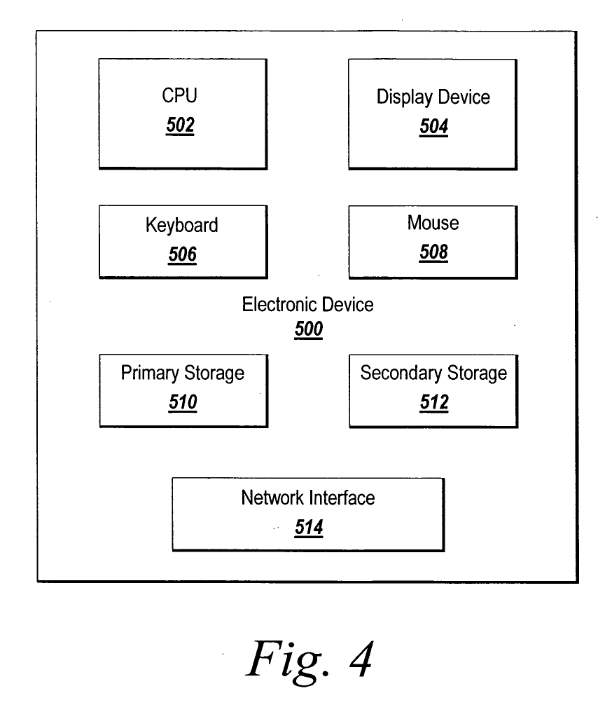

FIG. 4 illustrates one example embodiment of an electronic device 500 suitable for practicing the illustrative embodiments of the present invention, including serving as all or a portion of the communication enabler 18. The electronic device 500 is representative of a number of different technologies, such as personal computers (PCs), laptop computers, workstations, personal digital assistants (PDAs), Internet appliances, cellular telephones, and the like. In the illustrated embodiment, the electronic device 500 includes a central processing unit (CPU) 502 and a display device 504. The display device 504 enables the electronic device 500 to communicate directly with a user through a visual display. The electronic device 500 further includes a keyboard 506 and a mouse 508. Other potential input devices not depicted include a stylus, trackball, joystick, touch pad, touch screen, and the like. The electronic device 500 includes primary storage 510 and secondary storage 512 for storing data and instructions. The storage devices 510 and 512 can include such technologies as a floppy drive, hard drive, tape drive, optical drive, read only memory (ROM), random access memory (RAM), and the like. Applications such as browsers, JAVA virtual machines, and other utilities and applications can be resident on one or both of the storage devices 510 and 512. The electronic device 500 can also include a network interface 514 for communicating with one or more electronic devices external to the electronic device 500 depicted. A modem is one form of network interface 514 for establishing a connection with an external electronic device or network. The CPU 502 has either internally, or externally, attached thereto one or more of the aforementioned components.

It should be noted that the electronic device 500 is merely representative of a structure for implementing the present invention. However, one of ordinary skill in the art will appreciate that the present invention is not limited to implementation on only the described device 500. Other implementations can be utilized, including an implementation based partially or entirely in embedded code, where no user inputs or display devices are necessary. Rather, a processor can communicate directly with another processor or other device.

Various levels of security and anonymity can be maintained using the method of the present invention. The range can include providing communication links A and B between the source party 10 and the designated party 12 without either party gaining any additional information about each other in addition to the actual content of the messages sent through the communication links, and with firewalls and virus protectors in place. The range can also include the source party 10 and the designated party 12 being able to view caller ID information, contact information including mailing address, phone number, and email address, or even images of the individual, entity, or device. As understood by one of ordinary skill in the art, the present invention also anticipates all variations of levels of security and anonymity between the aforementioned range extremes.

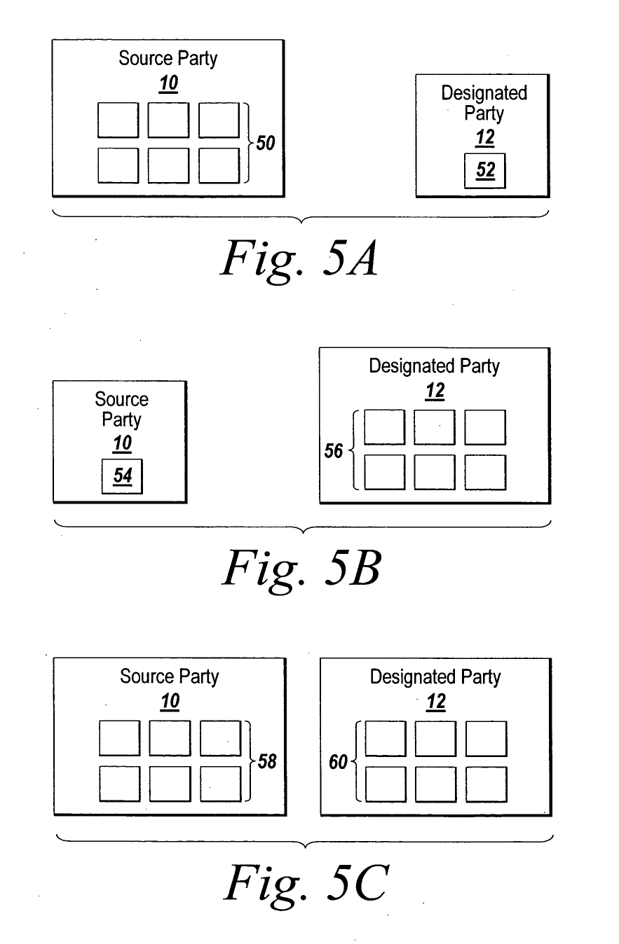

In addition, the present invention is useful for establishing communication links on a 1:1 basis, a 1:many basis, a many:1 basis, and a many:many basis. The 1:1 basis is captured by the example of a single individual, entity, or device identifying another individual, entity, or device and requesting a communication link as described in the above examples. The many:1 basis is exemplified by a group of individuals (such as at a conference or resort) requesting communication links with a single individual, such as a, or a speaker having just spoken to the group, and as shown in FIG. 5A. The source party 10 is made up of a plurality of members 50, each having the ability to identify an individual 52 as the designated party. The 1:many basis is exemplified by the situation where an individual, such as a manager or site operator, wants to send the same message to a group of individuals, such as employees. FIG. 5B illustrates this example, wherein an individual 54 as the source party 10 has the ability to identify a group of individuals 56 as the designated party 12. The many:many instance is shown in FIG. 5C. A group of individuals 58 can form the source party 10 and they have the ability to identify another group of individuals 60 as the designated party 12. Some of the “many” groups can be set up by configuring the correspondence list to include all of the members of the “many” group.

It should be noted that in the above examples, groups can be of arbitrary and differing sizes. In addition, there is no requirement that all group members be available to receive requests. Sub-sets of group members can be communicated with using the present invention based on additional criteria, such as location (determined by range of the transmitter in the communication enabler 18).

It should further be noted that the present invention has application in a number of different settings and environments from traffic on the streets and other transportation environments, to emergency and first response groups, to various other group environments such as resort environments, group meeting environments, social engagement environments, conference environments, a transportation environment, and other events or environments. Any situation where an individual or entity may want or have the ability to identify a designated party by a designated party identifier and establish a communication link with that designated party is a situation that can be aided by the system and method of the present invention.

Implementation of the present invention can make use of standard state-of-the-art call processing features available in the telephone and communications industry as well as computational and data base technologies which are readily available and familiar to those versed in the art. Another example embodiment of the invention includes a link between the (voice) messaging network and another application such as short text messaging to allow a simple billing structure.

The present invention addresses the limitations of conventional telephony and other conventional forms of electronic communication, while maintaining privacy and specificity of message delivery. It is specifically useful to facilitate voice and message communications and may be implemented to provide multiple message delivery modes including voice and text.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

1. In an electronic device, a method of establishing a communication link, comprising:
receiving a request for communication from a source party including a designated party identifier based on a designated party tag;
associating the designated party identifier with a matching designated party;
completing the communication link between the source party and the designated party.

2. The method of claim 1, wherein completing the communication link comprises:
forwarding the request for communication to the matching designated party;
receiving an instruction from the matching designated party to establish the communication link; and
opening the communication link between the source party and the designated party.

3. The method of claim 1, wherein completing the communication link comprises:
opening the communication link between the source party and the designated party without receiving an instruction from the designated party.

4. The method of claim 1, wherein the source party sends the request using a wireless device.

5. The method of claim 1, wherein the source party sends the request using at least one of a mobile phone, a personal digital assistant, and a wireless communicator.

6. The method of claim 1, wherein the designated party tag comprises at least one of a designated party optical cue and a designated party transmission.

7. The method of claim 6, wherein the designated party optical cue comprises at least one of visual tags, license plates, number tags, bar-codes, scannable codes, printed T-shirts, signs, pins, buttons, badges, arm bands, bibs, name tags, and displays of distinguishing information.

8. The method of claim 6, wherein the designated party transmission comprises at least one of near infra-red (NIR) tag signals, RF-ID tag signals, transponder signals, magnetic signals, Bluetooth signals, IR signals, wireless Ethernet signals, RF signals, WiFi signals, GPS, and optical signals.

9. The method of claim 1, wherein associating the designated party identifier with a matching designated party comprises comparing the designated party identifier against a correspondence list to match the designated party with the designated party identifier.

10. The method of claim 9, wherein the correspondence list comprises a list of at least one designated party identifier, and a correlation between the at least one designated party identifier and at least one designated party.

11. The method of claim 10, wherein the correspondence list further comprises information conveying a method for contacting the at least one designated party.

12. The method of claim 1, wherein forwarding the request for communication to the matching designated party comprises transmitting a signal to the matching designated party indicating the existence of the request for the communication link.

13. The method of claim 1, wherein completing the communication link comprises electronically linking the source party with the designated party to enable the conveyance of information between the source party and the designated party.

14. The method of claim 1, wherein the source party and the designated party are each comprised of at least one of an individual, a plurality of individuals, an entity, a plurality of entities, an electronic device, and a plurality of electronic devices.

15. The method of claim 1, wherein the source party indicates whether to convey identification information about the source party to the designated party.

16. The method of claim 15, wherein the source party bases the conveyance of identification information on the occurrence of a condition.

17. The method of claim 16, wherein the condition comprises at least one of the designated party accepting and instructing the request, the designated party conveying identification information about the designated party to the source party, and membership in a pre-determined group.

18. The method of claim 1, wherein the designated party indicates whether to convey identification information about the designated party to the source party.

19. The method of claim 18, wherein the designated party bases the conveyance of identification information on the occurrence of a condition.

20. The method of claim 19, wherein the condition comprises the source party conveying identification information about the source party to the designated party.

21. The method of claim 1, wherein prior to receiving the request for communication from the source party the designated party subscribing to a service providing the method of establishing the communication link.

22. The method of claim 1, wherein the request for communication comprises a digital image.

23. The method of claim 1, further comprising forwarding a billing message conveying billing information to at least one of the source party, the designated party, and a third party organizer, based on use of the communication link.

24. The method of claim 1, wherein the method is implemented in at least one of a resort environment, a group meeting environment, a social engagement environment, a transportation environment, an emergency response environment, and a conference environment.

25. A method of establishing a communication link, comprising:
a source party sending a request for communication with a designated party including a designated party identifier based on a designated party tag; and
one of receiving an indication of the request being declined, and receiving an indication of the request being accepted and the communication link being completed.

26. The method of claim 25, wherein the source party sends the request using a wireless device.

27. The method of claim 25, wherein the source party sends the request using at least one of a mobile phone, a personal digital assistant, and a wireless communicator.

28. The method of claim 25, wherein the designated party tag comprises at least one of a designated party optical cue and a designated party transmission.

29. The method of claim 28, wherein the designated party optical cue comprises at least one of visual tags, license plates, number tags, bar-codes, scannable codes, printed T-shirts, signs, pins, buttons, badges, arm bands, bibs, name tags, and displays of distinguishing information.

30. The method of claim 28, wherein the designated party transmission comprises at least one of near infra-red (NIR) tag signals, RF-ID tag signals, transponder signals, magnetic signals, Bluetooth signals, IR signals, wireless Ethernet signals, RF signals, WiFi signals, GPS, and optical signals.

31. The method of claim 25, wherein the designated party identifier is compared with a correspondence list to match the designated party with the designated party identifier.

32. The method of claim 31, wherein the correspondence list comprises a list of at least one designated party identifier, and a correlation between the at least one designated party identifier and at least one designated party.

33. The method of claim 32, wherein the correspondence list further comprises information conveying a method for contacting the at least one designated party.

34. The method of claim 25, wherein the communication link being completed comprises electronically linking the source party with the designated party to enable the conveyance of information between the source party and the designated party.

35. The method of claim 25, wherein the source party and the designated party are each comprised of at least one of an individual, a plurality of individuals, an entity, a plurality of entities, an electronic device, and a plurality of electronic devices.

36. The method of claim 25, wherein the source party indicates whether to convey identification information about the source party to the designated party.

37. The method of claim 36, wherein the source party bases the conveyance of identification information on the occurrence of a condition.

38. The method of claim 37, wherein the condition comprises at least one of the designated party accepting and instructing the request, the designated party conveying identification information about the designated party to the source party, and membership in a pre-determined group.

39. The method of claim 25, wherein the designated party indicates whether to convey identification information about the designated party to the source party.

40. The method of claim 39, wherein the designated party bases the conveyance of identification information on the occurrence of a condition.

41. The method of claim 40, wherein the condition comprises the source party conveying identification information about the source party to the designated party.

42. The method of claim 25, wherein prior to receiving the request for communication from the source party the designated party subscribing to a service providing the method for establishing the communication link.

43. The method of claim 25, wherein the request for communication comprises a digital image.

44. The method of claim 25, further comprising receiving a billing message conveying billing information based on use of the communication link.

45. The method of claim 44, wherein the billing message is not incorporated into a bill from a network host of the source party.

46. The method of claim 25, wherein the method is implemented in at least one of a resort environment, a group meeting environment, a social engagement environment, a transportation environment, an emergency response environment, and a conference environment.

47. A communication system for establishing a communication link, comprising:
a receiver for receiving communications from a source party and a designated party;
a request processor for processing a request for establishing the communication link;
a database accessible by the electronic device, wherein the database stores a correspondence list correlating at least one attribute from the request that corresponds to at least one designated party with information conveying a method for contacting the at least one designated party; and
a transmitter for transmitting communications to the source party and the designated party.

48. The system of claim 47, wherein the source party sends the request using a wireless device.

49. The system of claim 47, wherein the source party sends the request using at least one of a mobile phone, a personal digital assistant, and a wireless communicator.

50. The system of claim 47, wherein the at least one attribute comprises a designated party tag.

51. The system of claim 47, wherein the at least one attribute comprises at least one of visual tags, license plates, number tags, bar-codes, scannable codes, printed T-shirts, signs, pins, buttons, badges, arm bands, bibs, name tags, and displays of distinguishing information.

52. The system of claim 47, wherein the at least one attribute comprises at least one of near infra-red (NIR) tag signals, RF-ID tag signals, transponder signals, magnetic signals, Bluetooth signals, IR signals, wireless Ethernet signals, RF signals, WiFi signals, GPS, and optical signals.

53. The system of claim 47, wherein the transmitter for transmitting communications to the source party and the designated party serves as a relay between the source party and the designated party forming the communication link.

54. The system of claim 47, wherein the source party and the designated party are each comprised of at least one of an individual, a plurality of individuals, an entity, a plurality of entities, an electronic device, and a plurality of electronic devices.

55. The system of claim 47, wherein the request for establishing the communication link comprises a digital image.

56. The system of claim 47, wherein the source party and the designated party are located in at least one of a resort environment, a group meeting environment, a social engagement environment, a transportation environment, an emergency response environment, and a conference environment.

57. The system of claim 47, wherein at least one of the source party and the designated party are members in a pre-determined group.

58. The system of claim 47, wherein billing messages originate with the system and are distinct from source party and designated party host network billing systems.

59. A medium for use in combination with an electronic device, the medium holding instructions executable using the electronic device for performing a method of establishing a communication link, the method comprising:
receiving a request for communication from a source party including a designated party identifier based on a designated party tag;
associating the designated party identifier with a matching designated party; completing the communication link between the source party and the designated party.

60. A medium for use in combination with an electronic device, the medium holding instructions executable using the electronic device for performing a method of establishing a communication link, the method comprising:
a source party sending a request for communication with a designated party including a designated party identifier based on a designated party tag; and
one of receiving an indication of the request being declined, and receiving an indication of the request being accepted and the communication link being completed.
